(19) United States
(12) Patent Application Publication
(10) Pub. No.: US 2003/0144914 A1
(43) Pub. Date: Jul. 31, 2003

(54) Internet-based ordering system with multiply-interfaced shopping cart

(76) Inventors: Brad Gossard, Maysville, KY (US); Pete DiFrank, Edgewood, KY (US); Frederick Jefferds, Florence, KY (US); Jeff Lee, Highland Heights, KY (US)

Correspondence Address: HARNESS, DICKEY & PIERCE, P.L.C., P.O. BOX 828, BLOOMFIELD HILLS, MI, 48303, US

(21) Appl. No.: 10/060,424

(22) Filed: Jan. 30, 2002

(51) Int. Cl. G06F 17/60

(52) U.S. Cl. 705/26

(57) ABSTRACT

An interfacing method for use with an internet-based ordering system is disclosed, wherein the internet-based ordering system implements an electronic shopping cart. The method comprises receiving an ordering selection, wherein the ordering selection is unacceptable by the electronic shopping cart, and converting the ordering selection, thereby obtaining a converted selection, wherein the converted selection is acceptable by the electronic shopping cart. The method further comprises communicating the converted selection to the electronic shopping cart.

### FIELD OF THE INVENTION

The present invention generally relates to ecommerce systems and particularly relates to data index and retrieval systems in an internet-based ordering system.

### BACKGROUND OF THE INVENTION

There is considerable interest today in providing users access to product ordering selections in ecommerce systems. In response to various users' needs, different types of product ordering selection index and retrieval systems have been developed.

One index and retrieval system for servicing customers in an ecommerce system is the product catalogue. This type of application resource provides users access to ordering selections indexed by product type, product category, product part number, and/or product description. Thus, the product catalogue provides users access to products by simple lookup functions. Additional types of index and retrieval systems also exist.

Another type of index and retrieval system for servicing customers in an ecommerce system is the product interchange tool. This type of application resource provides users access to ordering selections indexed by competitor part number. Thus, the product interchange tool permits retailers of a product, for example, to look up an ordering selection for a compatible product that fills a customer's needs based on information related to competitor's products. Further types of index and retrieval systems also exist.

A further type of index and retrieval system for servicing customers in an ecommerce system is the configurator tool. This type of application resource provides users access to ordering selections indexed by configurability characteristics and/or performance characteristics. Thus, a user may select a category of product, for example, and enter required performance characteristics to retrieve one or more matching products within that category. Similarly, a user may select a type of system to design, and thus retrieve ordering selections based on configurability with previously selected products. Still further types of index and retrieval systems exist, and more will likely be developed to meet user's needs, but a common feature of an internet-based ordering system that employs these index and retrieval systems is a requirement that ordering selections be dropped into an electronic shopping cart.

One of the main conveniences associated with the practice of dropping ordering selections into an electronic shopping cart for storage during a shopping session is that the ordering selections may be processed for sale as a group at the end of the session. This sale process generally involves generating a bill of materials, taking and/or accessing payment and/or shipping information, and/or processing a shipping order for each of the products indicated by the respective ordering selections. Additional conveniences also exist, and include the ability to save information relating to previous shopping sessions. In addition to other benefits, this ability to save information allows sessions to continue from where they left off, so that the sales process may occur at a later session without having to access and retrieve the information anew. Unfortunately, however, past ordering systems have not permitted users to drop ordering selections from different types of application resources into the same shopping cart, and this failing has occurred for several reasons.

The main reason that past ordering systems have not permitted users to drop ordering selections from different types of application resources into the same shopping cart is that these systems have been constructed in different ways. Ordering selections of one application resource, for example, may be objects of different types, even where these ordering selections contain the same types of information. Thus, simple incompatibility between ordering systems is a major reason for users' having to use different shopping carts with different application resources, thereby requiring separate shopping sessions. Additional reasons also exist.

An additional reason that past ordering systems have not permitted users to drop ordering selections from different types of application resources into the same shopping cart is that the ordering selections of different systems must generally be customized for the particular form of index and retrieval process implemented by the application resources associated with those ordering systems. As discussed above, ordering selections of different types of application resources grant access to ordering selections that have different types of information associated with them for indexing purposes, and these differences mandate corresponding differences in data structure and/or object type according to the associated information.

Thus, differences in construction may compound with differences in material to arrive at incompatible types of ordering selections. Hence, a need remains for an internet-based ordering system that permits users to drop ordering selections of different types into the same shopping cart. Fulfilling that need remains the task of the present invention.

### SUMMARY OF THE INVENTION

In one aspect, the present invention is an interfacing method for use with an internet-based ordering system, wherein the internet-based ordering system implements an electronic shopping cart. The method comprises receiving an ordering selection, wherein the ordering selection is unacceptable by the electronic shopping cart, and converting the ordering selection, thereby obtaining a converted selection, wherein the converted selection is acceptable by the electronic shopping cart. The method further comprises communicating the converted selection to the electronic shopping cart.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of an internet-based ordering system employing the interface module of the present invention;

FIG. 2 is a flow chart diagram depicting the interfacing method of the present invention;

FIG. 3 is a block diagram of an internet-based ordering system according to the present invention

### DETAILED DESCRIPTION OF THE PREFERRED EMBODIMENTS

The following description of the preferred embodiment(s) is merely exemplary in nature and is in no way intended to limit the invention, its application, or uses.

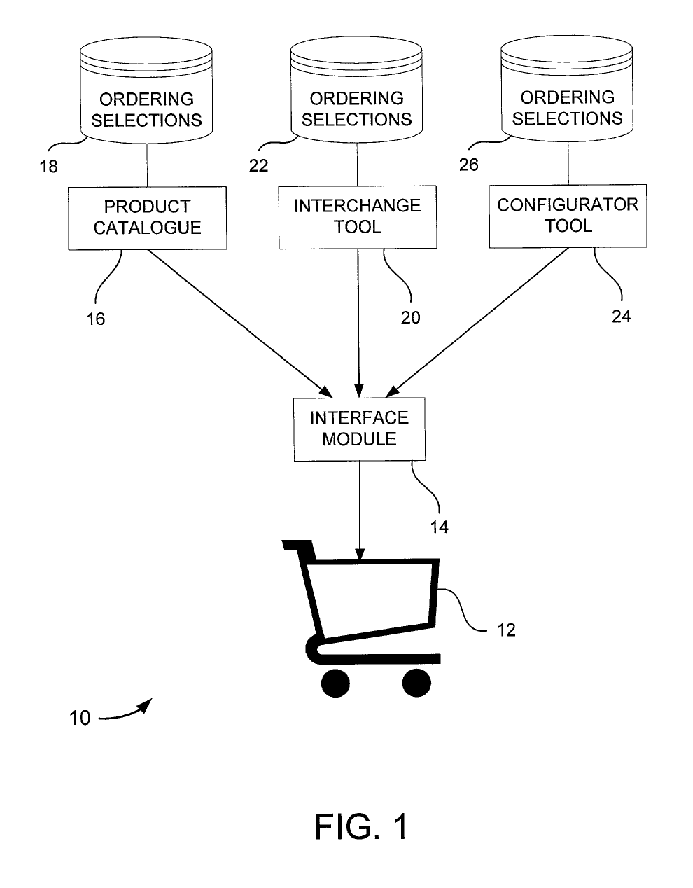

Referring to FIG. 1, an internet-based ordering system 10 according to the present invention has an electronic shopping cart 12, and a plurality of application resources in communication with the electronic shopping cart 12 via an interface module 14. A product catalogue 16 of the plurality of application resources provides users access to ordering selections 18 based on a first type of look-up function(s), and a product interchange tool 20 of the plurality of application resources provides users access to ordering selections 22 based on a second type of look-up function. Likewise, a configurator tool 24 of the plurality of application resources provides users access to ordering selections 26 based on algorithmic functions. In accordance with the present invention, users may drop ordering selections from any of the plurality of application resources into the electronic shopping cart 12, and this functionality is owed to a particular component.

The interface module 14 is the component of the internet-based ordering system 10 that permits users to drop ordering selections from any of the plurality of application resources into the electronic shopping cart 12, and the interface module 12 may perform its function in a number of ways demonstrable according to various examples.

In a first example, the electronic shopping cart 12 readily accepts ordering selections 18, but not ordering selections 22 or ordering selections 26. Further to the first example, ordering selections 18, 22, and 26 refer to a same plurality of products, but consist of different types of information stored in different object types that are arranged and interrelated in different ways. Ordering selections 18, for example, may be arranged by category with fields including name, part number, price, and description. Dissimilarly, ordering selections 22 may be arranged by competitor with fields including competitor's part name, name, competitor's part number, part number, competitor's price, price, shipping options, and availability. Further, ordering selections 26 may be arranged by category and/or system with fields including name, part number, price, performance characteristics, and/or configurability characteristics. Sample performance characteristics include lifespan under various conditions, while sample configurability characteristics include physical dimensions and/or connectivity. Thus, interface module 14 must convert ordering selections 22 and 26 to ordering selections 18 in any of several ways.

One way interface module 14 can convert ordering selections 22 and 26 to ordering selections 18 is to generate a new ordering selection 18 based on information associated with the ordering selection 22 or 26. Thus, upon receipt of an ordering selection 22, a new ordering selection may be generated of the appropriate type that includes the name, part number, and price fields based on those contained in the ordering selection 22, and which has the description field set to null or containing a proxy description. Ordering selections 26 may be similarly converted based on the included name, part number, and price. Thus, the converted selections may differ from ordering selections 18, but are acceptable by electronic shopping cart 12. There are additional ways, however, of converting ordering selections 22 and 26.

Another way of converting ordering selections 22 and 26 to ordering selections 18 is to retrieve a corresponding ordering selection 18 based on the received ordering selection 22 or 26. This method is particularly facilitated where the ordering selections contain additional fields that indicate a memory location leading to the corresponding ordering selection 18, but a search may also be performed of ordering selections 18 based on common fields such as name and/or part number. Thus, the converted selections may be the same as ordering selections 18, and are thus acceptable to the electronic shopping cart 12. Additional ways in which interface module 18 may function are demonstrable with reference to further examples.

In a further example, none of ordering selections 18, 22, or 26 are acceptable by electronic shopping cart 12, so that each ordering selection 18, 22, and 26 must be converted to an acceptable form in any of several ways. One way of converting the ordering selections 18, 22, and 26 to an acceptable form is to simply wrap each ordering selection 18, 22, and 26 in an object wrapper acceptable by electronic shopping cart 12, and this technique is most appropriate where electronic shopping cart 12 has been coupled with a complementary automated billing procedure that can handle various types of ordering selections. Another way of converting the ordering selections 18, 22, and 26 to an acceptable form is to generate a new ordering selection in the manner detailed above according to a format and process that complements the construction of the electronic shopping cart 12 and the associated automated billing procedure. Further examples also prove demonstrative.

In a further example, ordering selections 18, 22, and 26 refer to different products by different suppliers, and/or manufacturers. In this example, the wrapping method discussed above is likely most appropriate, as a complementary order management application will likely be necessary. It is also possible, however, to generate converted ordering selections based on similar fields and by setting dissimilar fields to null and/or providing proxy information as discussed above where the order management application accommodates such an ordering selection. Further, it is possible to have an additional database of ordering selections that refer to all of the same products as ordering selections 18, 22, and 26, wherein these additional ordering selections are acceptable to electronic shopping cart 14. In that case, it is possible to retrieve corresponding ordering selections as discussed above. Thus, additional examples of use for the present invention may be extrapolated from the previous examples.

Additional examples that may be extrapolated from the preceding disclosure include, for example, multiple product catalogues having catalogue ordering selections referring to products, wherein some catalogue ordering selections must be converted to allow them to be dropped into the electronic shopping cart 12. Further to this example, product catalogues of different retailers may refer to some, all, or none of the same products, but the present invention would allow users to purchase from the different retailers in one session, thereby accomplishing an electronic mall with complementary order management application(s). Thus, various applications of the present invention may be accomplished, where the processes involved in the method of the present invention may vary, but the advantages of the invention are clear.

In relation to the advantages of the present invention, a particular application of the present invention to accomplish an electronic shopping mall demonstrates that the present invention allows incorporation of a greater portion of retailers' existing ecommerce systems. For example, if a first retailer and a second retailer have existing online ordering systems, but wish to join an electronic mall, the retailers' ordering applications with their existing ordering selection databases may be incorporated into the electronic mall via the present invention. Further, the mall may incorporate a copy of the retailers' ordering applications or link to existing web servers providing access to the ordering selections. Thus, retailers' may have the choice whether to liquidate assets, like their current web servers, by turning over responsibilities of ordering selection access and retrieval responsibilities to the electronic mall, and this choice may hinge on whether the electronic shopping mall takes over order management responsibilities as well. In either case, the order management applications of the retailers may optionally be incorporated into the electronic shopping mall.

The order management applications of the retailers may optionally be incorporated in the electronic shopping mall if the interface module of the multiply interfaced shopping cart has the ability to sort the selections by retailer and communicate them to the retailers' order management applications. This ability may be facilitated where the ordering selections are labeled during the conversion process to identify the particular retailer and/or source ordering application; but if each retailers' ordering selection is identifiable according to its unique characteristics, the order management module may be adapted to sort the selections based on those characteristics. If wrapped, for example, converted selections may be unwrapped, identified according to object type, and communicated to an appropriate order management system. The object wrapper may also or alternatively identify the source ordering application or destination order management application. As above, the retailer's order management applications may be copies of the original ordering applications resident on the electronic shopping mall's web server, or resident on the retailers' web servers. On the whole, the order management application implemented with the present invention may vary across a spectrum.

The order management application may vary across a spectrum from a simple printout of ordering selections, credit card information, and/or shipping information to a fully automated billing and shipping procedure. At one end of this spectrum, mall personnel manually process single or multiple credit card payments and shipping orders for each retailer. At the other end of this spectrum, ordering selections are automatically sorted by retailer, billed, and processed as shipping orders. In the middle of this spectrum, one or more of the procedures is automated, such as billing, while another, such as shipping, is performed manually by electronic mall personnel. Variations on the theme of the electronic shopping mall can accomplish other applications, further demonstrating advantages of the present invention.

Further to the advantages of the present invention, the order management application may perform one billing and shipping procedure on behalf of the electronic shopping mall rather than the retailers. This alternative supports an application of the present invention better termed as an electronic supermarket, wherein the application likely joins together ordering applications of suppliers rather than retailers for an inventory of products maintained by the electronic supermarket. Thus, the present invention eliminates the need to construct anew an ordering application with ordering selections acceptable to an electronic shopping cart, where separate applications already exist that cover the ordering selections. The electronic mall application in particular permits customers to do their online shopping seemingly in one place, with one shopping cart, one session, and one billing and shipping procedure.

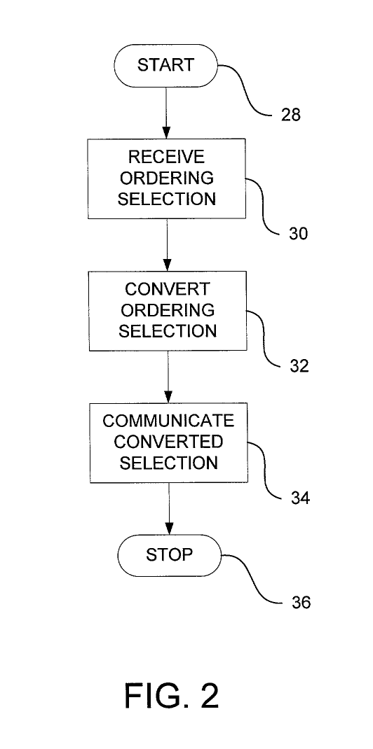

Referring to FIG. 2, the method of the present invention is simply expressed. Beginning at 28 and proceeding to step 30, an ordering selection is received, wherein the ordering selection is not acceptable by an electronic shopping cart. Proceeding to step 32, the ordering selection is converted to a converted selection, wherein the converted selection is acceptable by the electronic shopping cart. This conversion may be accomplished in any one of several ways as discussed in detail above. Thus, proceeding to step 34, the converted ordering selection is communicated to the electronic shopping cart and processing stops at 36. Further to step 34, however, the communication may correspond to production of a propagating wave operable with a data processing system, wherein the wave comprises the converted selection, and transmission of the wave to or within the data processing system containing the electronic shopping cart. As a result of the communication, the converted selection is dropped into the electronic shopping cart, which corresponds to storing the converted selection in memory operable with a data processing system as a data structure. The converted selection may also be reconverted to a wave operable with a data processing system for communication to a user and/or an order management application. Implementation of the system and method of the present invention is demonstrated with a final example.

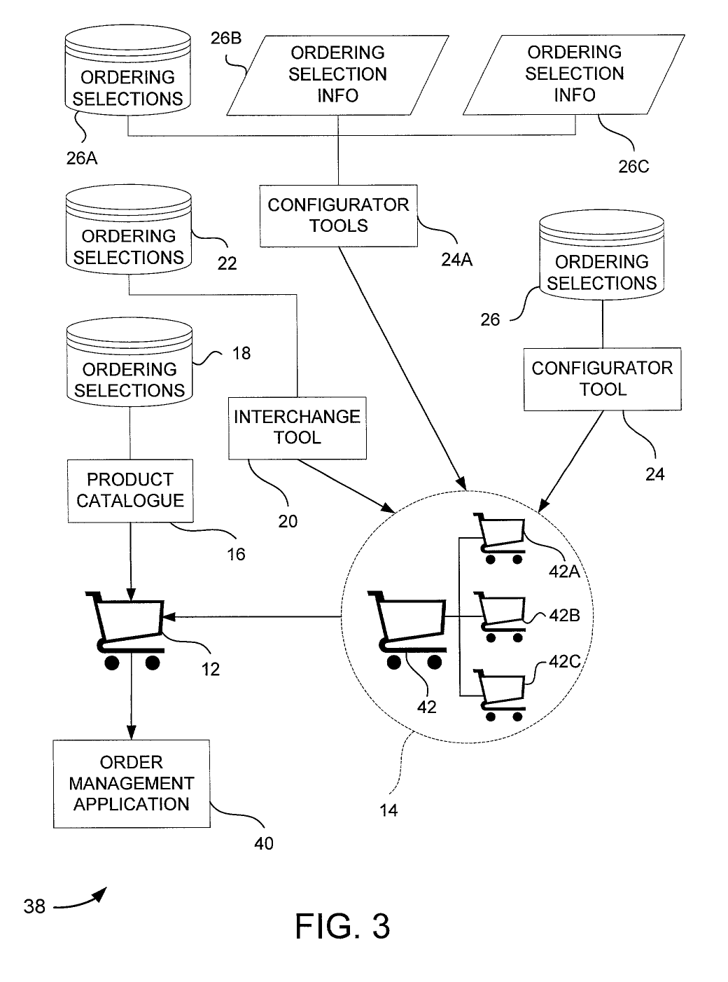

Referring to FIG. 3, an internet-based ordering system 38 comprises the ordering applications, electronic shopping cart module 12, and interface module 14 of internet-based ordering system 10 (FIG. 1) in combination with an order management application 40 (FIG. 3). In the preferred embodiment of the present example, product catalogue 16, has ordering selections 18 communicable in an acceptable format to electronic shopping cart 12 as strings consisting of Part Description, Part Name, Quantity, and Line Comments fields. Further, electronic shopping cart 12 only accepts ordering selections of type string with commas (“,”) delineating the fields of each ordering selection, and it assumes that the fields are concatenated in the appropriate order as detailed above. Still further, electronic shopping cart 12 can accept a string comprising a plurality of ordering selections adhering to the described format, wherein the ordering selections are separated by carat symbols (“\hat{ }”) In the preferred embodiment, electronic shopping cart 12 communicates its contents to order management application 40 in response to a customer command, and order management application 40 processes the ordering selections by billing them out to corresponding manufacturers.

Interface module 14 of the preferred embodiment comprises an interim electronic shopping cart 42 with contents belonging to a first group 42A, second group 42B, and third group 42C. The contents of interim electronic shopping cart 42 consist of a string of concatenated groupings that are delineated with group delineators. Each grouping represents an ordering selection that consists of a string of items delineated by item delineators, and each item in turn consists of fields of type string also delineated by item delimiters. Each group string begins with a label designating the first group 42A, second group 42B, or third group 42C, and additional labels may also follow to designate a configurator tool module of an ordering application from which the ordering selection originated or a proxy label. Further, each item consists of a string that may represent a part description, part name, competitor name, competitor part description, key to a configurator tool reference table, and/or a part number. It is the order in which the items are concatenated that assists in identifying the type of information represented by the item, and this order may vary from one group to another.

In operation, a customer may access the product catalogue 18 and drop ordering selections 18 into electronic shopping cart 12. The customer may also choose to access the product interchange tool 20 and, using the method of the present invention, drop ordering selections 22 into interim electronic shopping cart 42 where they can be viewed by the customer. Using the method of the present invention, the customer may further access configurator tool 24 and drop ordering selections 26 into interim electronic shopping cart 42 where they may be viewed by the customer in conjunction with ordering selection 22.

In the latter two cases, the ordering selections are labeled to designate the group to which they belong. For example, strings separated by item delimiters are generated based on interchange ordering selections 22 that are labeled (“I”) to designate that they belong to group 42A, whereas those generated based on configurator ordering selections are labeled to designate that they belong to group 42B. For the interchange-based strings of group 42A, these strings further comprise a proxy field (“ ”), and fields like competitor name, competitor part description, a number corresponding to a total number of parts less the number of rework parts in the grouping, part description, part name, and a number to designate part quantity. The label and other items are preferably concatenated in the following order:

“I” & ItemDelimiter & “ ” & ItemDelimiter & (Competitor Name) & ItemDelimiter & (Competitor Part Description) & ItemDelimiter & (TotalNumParts−NumReworks) & ItemDelimiter & (Part Description) & & (Part Name) & “1”

In contrast to those of group 42A, the strings of group 42B have a different label and fields. For example, configurator tool 24 has a plurality of modules for configuring an unmounted bearing selection, and the following ordered concatenation of fields is preferred:

“PU” & ItemDelimiter & (Module Number) & ItemDelimiter & (Table Key) & ItemDelimiter & (Part Number) & ItemDelimiter & “1” & ItemDelimiter & (Part Number) & ItemDelimiter & (Part Name) & ItemDelimiter & “1”

In further operation, the customer may access a plurality of configurator tools 24A having one or more modules that provide access to ordering selections 26A and/or ordering selection information data files 26B and 26C. The customer may drop ordering selections 26A into interim electronic shopping cart 42, and/or generate ordering selections based on data files 26B and 26C for dropping into interim electronic shopping cart 42. The customer may further view the ordering selections 26A in conjunction with ordering selections 22, ordering selections 26, and generated ordering selections that are present in the interim electronic shopping cart 42.

Specifically, string groupings are generated based on ordering selections 26A that are labeled to designate them as belonging to group 42C, and these string groupings possess many of the same fields listed above. Similarly, if ordering selections have not been grouped into a database, the necessary fields for ordering selection are retrieved from information data files. The following ordered concatenation of fields is preferred:

“P” & ItemDelimiter & (Module Number) & ItemDelimiter & (Table Key) & ItemDelimiter & (Part Number) & ItemDelimiter & (TotalNumParts−NumReworks) & ItemDelimiter & (Part Description) & ItemDelimiter & (Part Name) & ItemDelimiter & (Part Quantity)

In each case, groupings are concatenated into a string and separated by group delineators to form the contents of the interim electronic shopping cart 42, and customer commands regarding the contents. The interim electronic shopping cart 42 accomplishes content editing, for example, by splitting the contents into multidimensional arrays according to group and item, and identifying fields according to their place within a group. This method is extended to not only delete items and update quantity of items, but also to retrieve items for output related to viewing, reconfiguring, converting, and communicating of items. Sample pseudo code for getting items from contents is operable with the preferred, ordered concatenation of fields above and assumes that all necessary variables have been instantiated to 0 or null as appropriate except for Contents (the shopping cart string) and Item (a number selected by the customer), which are passed as arguments:

Groups = Split (Contents, GroupDelimiter)
for i = LBound (Groups) to UBound (Groups)

Items = Split (Groups (i), ItemDelimiter)
ItemCount = ItemCount + Items (4)
if ItemCount >= CInt (Item) then

ItemCount = ItemCount − Items(4)
for j = 1 to Items (4)

ItemCount = ItemCount + 1
if ItemCount = Item then

PartDescription = Items ((j−1)*3+5)
PartName = Items ((j−1)*3+6)
Quantity = Items ((j−1)*3+7)
if Items (0) = “P” then
LineComments = “Solution # ” & Items

(2) & “ (” & Items (3) &
“)”

else if Items (0) = “PU” then

LineComments = “Solution # ” & Items

(2)

else if Items (0) = “I” then

LineComments = “Interchange”

end if
exit sub

end if

next

end if

next

Given the preceding disclosure, one skilled in the art will recognize that traversal of the group arrays as disclosed above retrieves the Part Description, Part Name, and Quantity from the ordering selections stored as contents in interim electronic shopping cart 42, and that proxy information is generated for the Line Comments. Notably, Part Number serves as the Part Description in the case of unmounted bearings of group 42B. Thus, use of this method permits a customer to communicate one or more ordering selections from interim electronic shopping cart 42 to electronic shopping cart 12 by getting a selected item, concatenating a string of the resulting fields with commas as delineators, and concatenating the resulting strings with carat symbols as delineators. Hence, the customer may drop converted ordering selections from interim electronic shopping cart 42 into electronic shopping cart 12 where they can be viewed concurrently with ordering selections 18. Since the converted ordering selections of the preferred embodiment refer to the same or a subset of the same products as ordering selections 18, it is a simple matter for a customer to order the products by submitting the contents of electronic shopping cart 12 to order management application 40.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An interfacing method for use with an internet-based ordering system, wherein the internet-based ordering system implements an electronic shopping cart, the method comprising:
receiving an ordering selection, wherein the ordering selection is unacceptable by the electronic shopping cart;
converting the ordering selection, thereby obtaining a converted selection, wherein the converted selection is acceptable by the electronic shopping cart; and
communicating the converted selection to the electronic shopping cart.

2. The method of claim 1, the method further comprising reconverting the converted ordering selection, thereby obtaining the ordering selection.

3. The method of claim 2, the method further comprising outputting the ordering selection to a corresponding order management application.

4. The method of claim 1, wherein said receiving corresponds to generating the ordering selection based on information relating to the ordering selection.

5. The method of claim 3, wherein said converting includes labeling the converted selection, and wherein at least one of said reconverting and said outputting is based at least in part on said labeling.

6. The method of claim 1, wherein said converting corresponds to generating a new ordering selection based on information relating to the ordering selection.

7. The method of claim 6, wherein said generating corresponds to wrapping the ordering selection in an object wrapper.

8. The method of claim 6, wherein said generating corresponds to instantiating a new object having similar fields containing the information, wherein the new object has dissimilar fields at least one of:
a) set to null; and
b) containing proxy information.

9. The method of claim 1, wherein said converting corresponds to retrieving a corresponding ordering selection that refers to the same product, wherein the corresponding ordering selection is acceptable by the electronic shopping cart.

10. A propagating wave operable with a data processing system, the wave comprising the converted selection of claim 1.

11. A data structure stored in memory operable with a data processing system, the data structure comprising the converted selection of claim 1.

12. An interface module for use with an internet based-ordering system, the interface module operable according to the method of claim 1.

13. The interface module of claim 12, the module comprising an interim electronic shopping cart operable to receive and store groups of ordering selections from different ordering applications.

14. The interface module of claim 13, wherein the interface module is further operable to output contents of the interim electronic shopping cart for display to a customer.

15. The interface module of claim 14, wherein the interface module is operable to edit the contents in response to commands of the customer.

16. The interface module of claim 14, wherein the interface module is operable to perform said converting and said communicating of the contents in response to a command of the user.

17. An internet-based ordering system comprising:
an electronic shopping cart module; and
the interface module of claim 12.

18. The system of claim 17, the system further comprising a plurality of ordering applications, wherein each ordering application has an associated database of ordering selections.

19. The system of claim 18, wherein at least two of the databases include ordering selections representing products that are the same, and wherein the databases are indexed according to different criteria.

20. The system of claim 19,
wherein at least one ordering application is a product catalogue providing access to ordering selections indexed according to at least one of:
a) product name;
b) product category;
c) product part number; and
d) product description,
wherein at least one ordering application is a product interchange tool providing access to ordering selections indexed according to competitor's part number, and
wherein at least one ordering application is a configurator tool providing access to ordering selections indexed according to at least one of:
a) configurability characteristics of each respective ordering selection; and
b) performance characteristics of each respective ordering selection.
